(19) United States
(12) Patent Application Publication
(10) Pub. No.: US 2008/0155172 A1
(43) Pub. Date: Jun. 26, 2008

(54) MICROCODE PATCHING SYSTEM AND METHOD

(75) Inventor: Ming Hung Li, Taichung County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 11/615,059

(22) Filed: Dec. 22, 2006

(51) Int. Cl. G06F 12/06; G06F 12/00

(52) U.S. Cl. 711/102; 711/215; 711/E12.083

(57) ABSTRACT

A microcode patching system, including a memory unit comprising a first memory storing at least one microcode main instruction and a second memory providing at least one microcode patch instruction, accessed according to a selected output address, an address selecting unit providing a first output address, and a trap and patch logic unit coupled between the address selecting unit and the memory unit, determining if the first output address matches any of at least one bug address, and selecting a selected patch address for accessing the second memory or the first output address as a second output address if the first output address matches one or none of the bug addresses, respectively, wherein the second output address is coupled to the memory unit.

### BACKGROUND OF THE INVENTION

1. Field of the Invention

The invention relates to embedded programs and more particularly to a system and a method for implementing a patch mechanism for an embedded read only memory (ROM).

2. Description of the Related Art

For a general purpose ASIC with an embedded processor (for example, ARM or DSP), program memory is needed to store instruction code. The program memory can be read only memory (ROM), random access memory (RAM), or a combination of both. Normally ROM is much smaller than RAM and stores the majority of instruction code incapable of modification after initialization. A patch mechanism is thus needed whenever an erroneous instruction code is stored within the ROM or more instruction code is needed to add when instruction code stored within the ROM is accessed and executed.

One patching mechanism bypasses the erroneous instruction code and replaces it with an instruction to redirect the processor to access a correct instruction code in a patch memory. An example is illustrated in FIG. 1, a block diagram of a circuit 100 disclosed in patent U.S. Pat. No. 6,891,765. As shown, the circuit 100 comprises a processor 102, a program space (memory) 104 comprising a program memory (ROM) 104a and a patch memory (RAM) 104b, a patch logic circuit 106, and a selection circuit 108. The processor 102 provides an address PAB to the memory 104, and the program space circuit 104 presents a data item DATA to the selection circuit 108 in response to the address PAB. Simultaneously, the processor 102 also provides the address PAB to the patch logic circuit 106. If the address PAB does not match any of a plurality of predetermined addresses requiring patching, repairing or expanding, the patch logic circuit 106 deasserts a command signal PTCH_DAT_SEL. However, if the address PAB matches one of the predetermined addresses, the patch logic circuit 106 asserts the command signal PTCH_DAT_SEL and generates a branch instruction PI redirecting the processor 102 to access the patch memory 104b. The selection circuit 108 selects an instruction item PDBI as the data item DATA received from the program space circuit 104 or the branch instruction PI received from the patch logic circuit 106 in response to the command signal PTCH_DAT_SEL and then sends the instruction item PDBI through the data bus 117 to the processor 102.

Another patch mechanism modifies the address sent to the ROM. Two examples are illustrated with circuits 200 and 300 in FIGS. 2 and 3 respectively disclosed in patents U.S. Pat. No. 6,438,664 and TWI 236,018. Referring to FIG. 2, a sequencer 92 controls multiplexer 86 to select the next address in the memory 64. The next address is sent to a next address register 94 to select a line from ROM 64a or a patch RAM 64b. The selected line is provided to an output register 80. The next address is also provided to the comparator 84. The Comparator 84 then compares the next address to values stored in a number of match registers 88. If the next address from the next address register 94 matches one of the match registers 88, then the comparator 84 selects a corresponding patch RAM address from look up table 90. The selected address in look up table 90 is supplied to MUX 86. The comparator 84 also indicates the occurrence of a match to the sequencer 92 such that the sequencer 92 controls MUX 86 to select the address from the look up table 90. The line that was fetched from ROM 64a into output register 80 is cancelled and a patch from patch RAM 64b is executed stating from the address indicated by look up table 90.

As shown in FIG. 3, the circuit 300 comprises a ROM 301, a RAM 303, a counter 305 and a comparing and loading unit 311. The counter 305 generates the next address 313 to access the ROM 301 or RAM 303. The counter 305 also provides the next address 313 to the comparing and loading unit 311. When the next address matches one of a number of predetermined addresses CHk1-CHk4 stored in the comparing and loading memory, the comparing and loading memory 311 sends a rest signal 317 and a jumping-in address signal 319 to the counter 313. The jumping-in address signal 319 represents one of a number of jumping-in addresses A₁-A₄ and the reset signal 317 resets the counter 313 to change the next address 313 to the address represented by the jumping address signal 319.

In the circuits 100, 200 and 300, the next address is sent not only to the ROM but also a circuit (patch logic circuit 106, comparator 84 or comparing and loading unit 311) to determine whether it matches any one of a number of predetermined addresses being patching, repairing or expanding. Resultantly, addresses of the ROM being patched, repaired, or expanded are still accessed to generate unnecessary instruction code abandoned or cancelled afterwards. Power and time are thus wasted upon accessing the ROM for the unnecessary instruction code. Additionally, the processor 102 in circuit 100, or sequencer 92 and multiplexer 86 in circuit 200, or counter 305 in circuit 300 needs to be redirected or reset to generate an address for accessing the patch memory. The resetting or redirecting interferes with normal process generating the next address of the ROM and wastes power and time.

### BRIEF SUMMARY OF THE INVENTION

Accordingly, the invention provides a microcode patching system in which ROM addresses being patched, repaired or expanded are not accessed and normal process generating the next address of the ROM is not interrupted to generate patch address of a patch memory, conserving power and time.

The invention provides a microcode patching system comprising a memory unit comprising a first memory storing at least one microcode main instruction and a second memory providing at least one microcode patch instruction, accessed according to a selected output address, an address selecting unit providing a first output address, and a trap and patch logic unit coupled between the address selecting unit and the memory unit. The trap and patch logic unit determines if the first output address matches any of at least one bug addresses, and selects a selected patch address for accessing the second memory or the first output address as a second output address if the first output address matches one or none of the bug address, respectively. The second output address is coupled to the memory unit.

The invention also provides a microcode patching method for accessing a memory unit comprising a first memory storing at least one microcode main instruction and a second memory storing at least one microcode patch instruction. The method comprises providing at least one bug address of the first memory, providing a first output address, determining if the first output address matches any of the bug addresses, outputting a second output address as a selected patch address for accessing the second memory or as the first output address if so and if not, respectively, and accessing the memory unit according to the second output address.

### BRIEF DESCRIPTION OF THE DRAWINGS

The invention can be more fully understood by reading the subsequent detailed description and examples with references made to the accompanying drawings, wherein:

FIG. 1 shows a conventional microcode patching system;

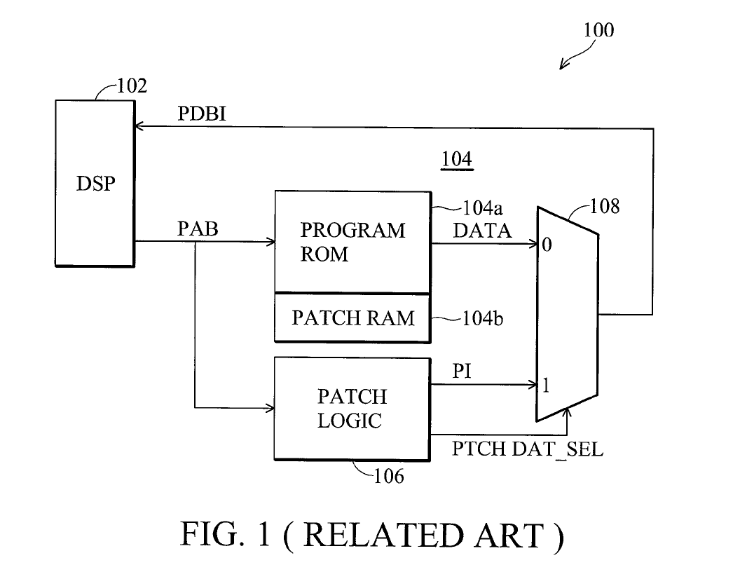

FIG. 2 shows another conventional microcode patching system;

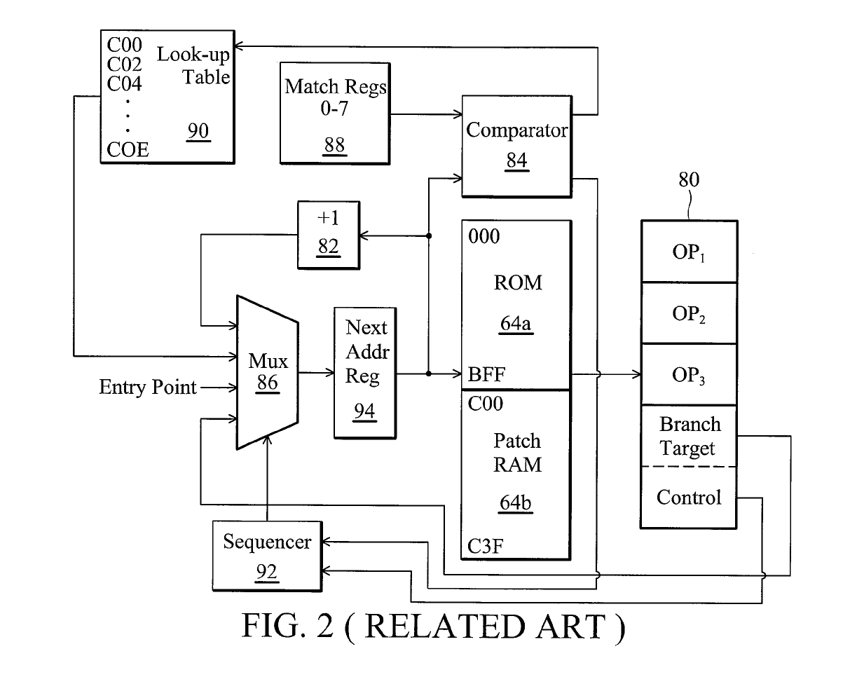

FIG. 3 shows further another conventional microcode patching system n;

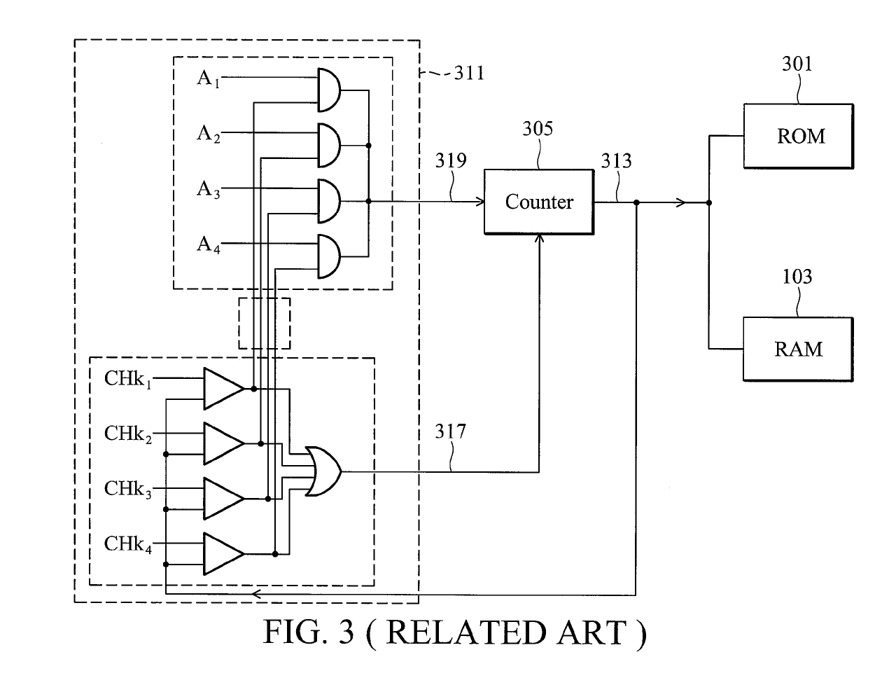

FIG. 4 is a block diagram of a microcode patching system in accordance with an embodiment of the invention;

FIG. 5 is a block diagram of a microcode patching system in accordance with another embodiment of the invention;

FIG. 6 is a block diagram of the trap and patch logic unit in FIGS. 4 and 5; and

FIG. 7 is a flowchart of a microcode patching method in accordance with an embodiment of the invention.

### DETAILED DESCRIPTION OF THE INVENTION

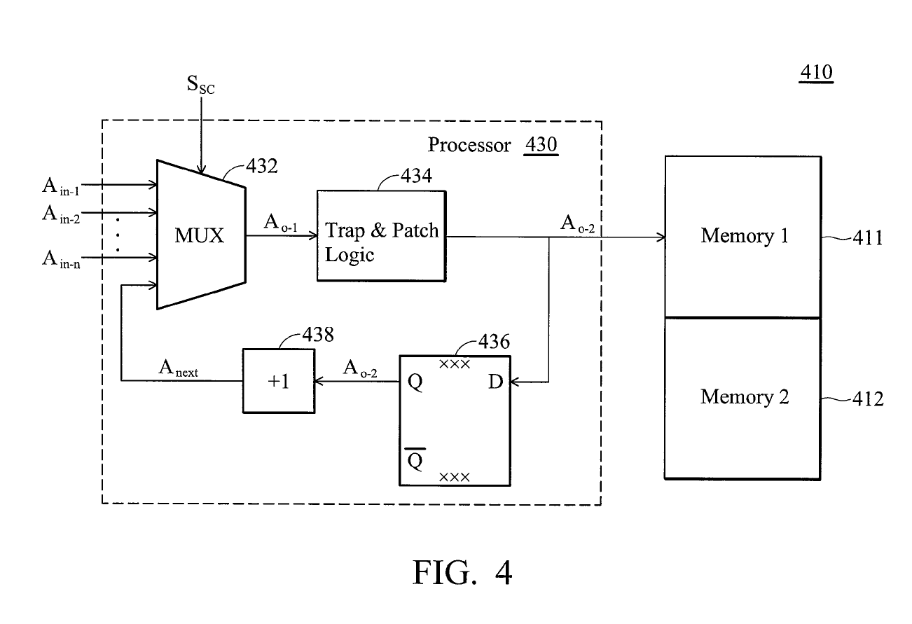

FIG. 4 is a block diagram of a microcode patching system 400 in accordance with an embodiment of the invention. As shown, the block diagram of a microcode patching system 400 comprises a memory unit 410 and a processor 430.

The memory unit 410 comprises a first memory 411 and a second memory 412. The first memory 411 may be implemented as a read only memory (ROM) spanning a first address range of the memory space of the memory unit 140 to store at least one microcode main instruction. The second memory 412 may be implemented as a random access memory (RAM) spanning a second address range of the memory space of the memory unit 140 to store at least one microcode patch instruction. The first and second memories 411 and 412 may be implemented as separate memories isolated from each other or first and second portions of a single memory, respectively.

As shown, the processor 430 comprises an address selecting unit 432, a trap and patch logic unit 434, an address register 436 and an address incrementer 438. The address selecting unit 432 receives a least one input target address (e.g., Aᵢₙ _{_{—}}₁-Aᵢₙ_{_{—}}ₙ) for accessing the first memory 411 and a next target address Aₙₑₓₜ from the address incrementer 438, selects one thereof as the first output address Ao_1 according to a sequential control signal S_{SC}, and then provides the first output address Ao_{—}_{¹} to the trap and patch logic unit 434. In an embodiment, the address selecting unit 432 is implemented as a multiplexer. The input target addresses Aᵢₙ_{_{—}}₁-Aᵢₙ_{_{—}}ₙ, for example, may comprise a destination address produced by an instruction decoder (not shown) to read a branch instruction stored in the first memory 411, a start address produced by an interruption control unit (not shown) to access interruption processing code stored in the first memory 411, and etc.

After receiving the first output address Aₒ_{_{—}}₁, the trap and patch logic unit 434 checks if the first output address Aₒ_{_{—}}₁ matches any of at least one bug address (e.g. A_{bug}_{_{—}}₁-A_{bug}_{_{—}}ₘ) indicating addresses for micro main instructions stored in the first memory 411 currently being patched, repaired or expanded, and then provides a second output address Aₒ_{_{—}}₂ determined according to the determination to access the memory unit 410.

If the first output address Aₒ_{_{—}}₁ matches one (e.g. A_{bug}_{_{—}}ᵢ) of the bug addresses A_{bug}_{_{—}}₁ to A_{bug}_{_{—}}ₖ, the trap and patch logic unit 434 selects one (e.g. A_{patch}_{_{—}}ᵢ) from at least one patch address (e.g. A_{patch}_{_{—}}₁- A_{patch}_{_{—}}ₘ) respectively corresponding to the bug addresses A_{bug}_{_{—}}₁-A_{bug}_{_{—}}ₘ and then outputs the selected patch address A_{patch}_{_{—}}ᵢ as the second output address Aₒ_{_{—}}₂ to access the second memory 412. Each of the patch address A_{patch}_{_{—}}₁-A_{patch}_{_{—}}ₘ is a starting address of an updating/debugging procedure stored in the second memory 142. And each updating/debugging procedure ends at a microcode patch instruction redirecting the processor to access back the first memory 411.

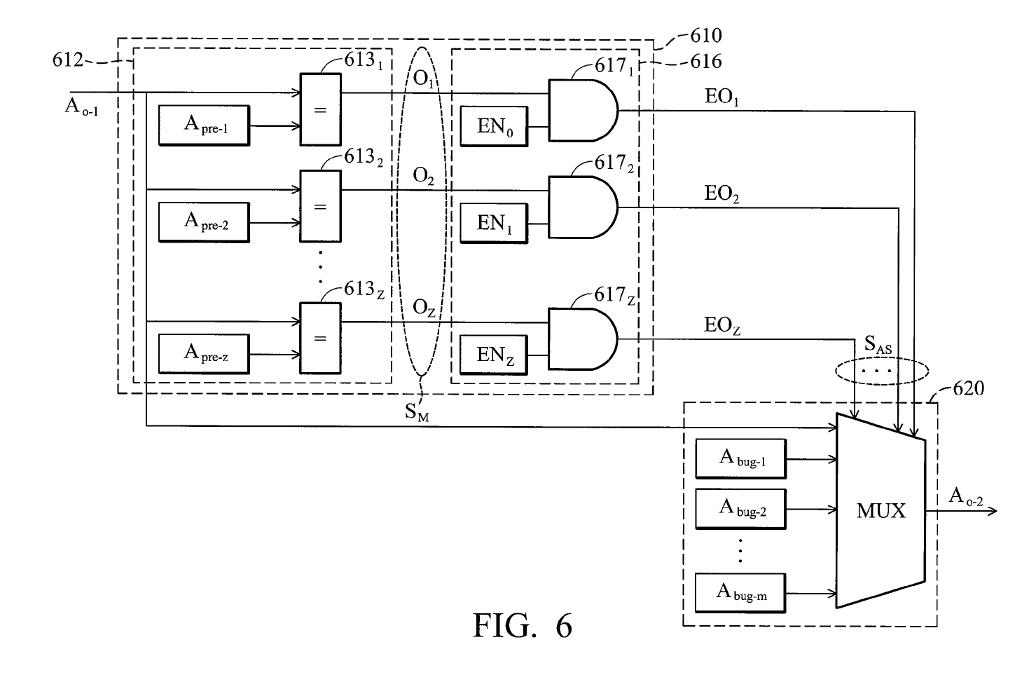

However, if the first output address Aₒ_{_{—}}₁ matches none of the bug addresses A_{bug}_{_{—}}₁ to A_{bug}_{_{—}}ₖ, the trap and patch logic unit directly outputs the first output address Aₒ_{_{—}}₁ as second output address Aₒ_{_{—}}₂ to access the memory unit 410. It is noted that the trap and patch logic unit 434 need not be disposed inside the processor 430 and may be disposed outside and independent of the processor 430. Detailed structure of the trap and patch logic unit 434 is given in descriptions related to FIG. 6.

The address register 436 registers and provides the second output address Aₒ_{_{—}}₂ to the address incrementer 438. The address incrementer 438 then increments the second output address Aₒ_{_{—}}₂ by a unit address (for example, 1) to provide the next target address Aₙₑₓₜ.

Accordingly, even if the first memory is a read only memory with unmodifiable data or instructions, replacing or adding data/instructions to the data or instructions stored in the first memory 411 is possible. For example, when microcode main instructions Cₕ-Cₕ₊ₘ indicated by addresses Aₕ-Aₕ₊ₘ of the first memory 411 need omitting, one bug address may be set as the address Aₕ with a patch address corresponding thereto indicating a microcode patch instruction set as directing the processor 430 to access the address Aₕ₊ₘ₊₁ of the first memory 411. In another example, when microcode main instructions Cₕ-Cₕ₊ₘ indicated by address Aₕ-Aₕ₊ₘ of the first memory 411 need replacing by microcode patch instructions indicated by address Aₚ-A_{q} of the second memory 412, one bug address A_{bug}_{_{—}}ᵢ may be set as the address Aₕ with a patch address corresponding thereto set as Aₚ, and microcode patch instruction of the address A_{q+1} of the second memory 412 may be set as redirecting the processor 430 to access address Aₕ₊ₘ₊₁ of the first memory 412. In further another example, when microcode main instructions indicated by address Aₚ-A_{q} of the first memory 411 are required to be inserted between microcode main instructions indicated by addresses Aₕ and Aₕ₊₁ of the first memory 411, one bug address may be set as the address Aₕ with a patch address corresponding thereto set as Aₚ, and microcode patch instruction of the address A_{q+1} of the second memory 412 may be set as redirecting the processor 430 to access address Aₕ₊₁ of the first memory 411.

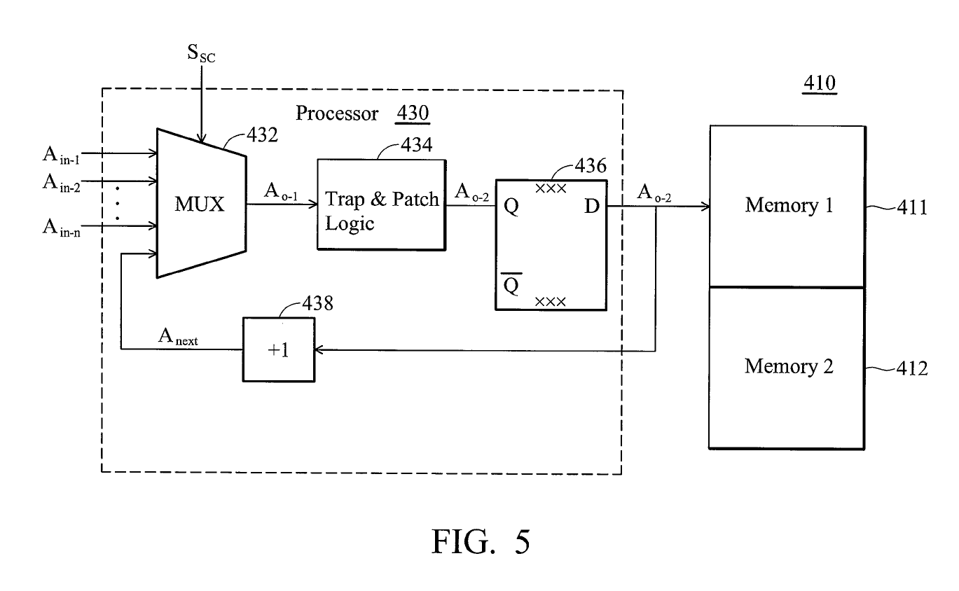

FIG. 5 is a block diagram of a microcode patching system 500 in accordance with another embodiment of the invention, differing from that in FIG. 4 only in that the address register 436 rather than the trap and patch logic unit 434 provides the second output address Aₒ_{_{—}}₂ to the memory unit 410. Details are similar and thus omitted for brevity.

FIG. 6 is a block diagram of the trap and patch logic unit 434 in FIGS. 4 and 5. As shown, the trap and patch logic unit 434 comprises a comparison module 610 and an address selector 620. The comparison module 610 determines if the first output address A_{—}_{^{o1}} matches any of at least one bug address (e.g. A_{bug}_{_{—}}₁-A_{bug}_{_{—}}ₘ) indicating addresses for micro main instructions stored in the first memory 104a currently being patched, repaired or expanded and provides the address selector 620 with an address selecting signal S_{AS} signal indicating which of the bug address matches the first output address A_{—}_{^{o1}}. After receiving the address selecting signal S_{AS} and the first output address A_{—}_{^{o1}}, the address selector 620 selects the second output address S_{—}_{^{o2}} from at least one patch address (e.g. A_{patch}_{_{—}}₁-A_{patch}_{_{—}}ₘ) respectively corresponding to the bug address (A_{bug}_{_{—}}₁-A_{bug}_{_{—}}ₘ) if the address selecting signal S_{AS} indicates one bug address matches the first output address A_{—}_{^{o1}}, or otherwise, the address selector 620 outputs the first output address A_{—}_{^{o1}} directly as the second output address A_{—}_{^{o2}}.

FIG. 6 also illustrates detailed respective structures of the comparison module 610 and the address selector 620. As shown, the comparison module 610 comprises a comparison unit 612 and an enable logic unit 616. The comparison unit 612 comprises a number of logic blocks 613₁-613_{z}. Each of the logic blocks 613₁-613ₘ may be implemented as a comparator comparing the first output address fₒ_{_{—}}₁ with one of a number of predetermined addresses Aₚᵣₑ_{_{—}}₁-Aₚᵣₑ_{_{—}}_{z} to generate a comparison output (O₁-O_{Z}) representing the comparison result. The predetermined addresses Aₚᵣₑ_{_{—}}₁-Aₚᵣₑ_{_{—}}_{z} may be received from address resisters 614₁-614_{z} (in the embodiment) or may be externally generated. The predetermined addresses Aₚᵣₑ_{_{—}}₁-Aₚᵣₑ_{_{—}}_{z} comprise the bug address A_{bug}_{_{—}}₁-A_{bug}_{_{—}}ₘ. Since the number of the bug address (m) is varied, not all of predetermined address Aₚᵣₑ_{_{—}}₁-Aₚᵣₑ_{_{—}}_{z} stored in the address resistors 614₁-614_{z} act as the bug address A_{bug}_{_{—}}₁-A_{bug}_{_{—}}ₘ. The comparison unit 612 then provides the enable logic unit 616 with a match signal S_{M} (i.e. comparison outputs O₁-O_{Z}) indicating which of the predetermined addresses Aₚᵣₑ_{_{—}}₁-Aₚᵣₑ_{_{—}}_{z} matches the first output address Aₒ_{_{—}}₁.

The enable logic unit 616 comprises a number of gates 617₁-617_{Z} each configured to enable/disable the comparison outputs O₁-O_{Z}. Since not all predetermined addresses Aₚᵣₑ_{_{—}}₁-Aₚᵣₑ_{_{—}}_{z} act as the bug address A_{bug}_{_{—}}₁-A_{bug}_{_{—}}ₘ for micro main instructions stored in the first memory 411 being patched, repaired or expanded, the enable logic gates 617₁-617_{Z} disables the comparison outputs from the logic blocks receiving the predetermined address not currently acting as the bug address, and enables the comparison outputs from the logic blocks receiving the predetermined address currently acting as the bug address.

Each of the gates 617₁-617_{Z} may be implemented as a logical AND gate (as shown) having a first input receiving an comparison output from one of the logic blocks 613₁-613_{z} and a second input receiving one of a number of enable bits (e.g., EN₀-EN_{Z}) to provide an enable output EO₁-EO_{Z}. The enable bits EN₀-EN_{Z} may be received from enable registers 618₁ to 618_{Z} (as shown) or may be externally generated. A ‘1’ of the enable bits EN₀-EN_{Z} enables the comparison outputs O₁-O_{Z} and a ‘0 ’ of the enable bits EN₀-EN_{Z} disables the comparison outputs O₁-O_{Z}. The enable logic unit 616 then outputs the address selecting signal S_{AS} (i.e. enable outputs EO₁-EO_{Z}) indicating which of the predetermined addresses Aₚᵣₑ_{_{—}}₁-Aₚᵣₑ_{_{—}}_{z} currently acting as the bug address A_{bug}_{_{—}}₁-A_{bug}_{_{—}}_{z} matches the first output address fₒ_{_{—}}₁.

FIG. 6 also illustrates detailed respective structures of the comparison module 610 and the address selector 620. As shown, the address selector 620 may be implemented as a multiplexer receiving the first output address fₒ_{_{—}}₁ and a number of patch addresses A_{patch}_{_{—}}₁-A_{patch}_{_{—}}ₘ to select one thereof as the second output address fₒ_{_{—}}₂ based on the address selecting signal S_{AS}. The patch addresses A_{patch}_{_{—}}₁-A_{patch}_{_{—}}ₘ may be received from address resisters 622₁-622ₘ or may be externally generated. The patch addresses A_{patch}_{_{—}}₁-A_{patch}_{_{—}}ₘ as described, may provide a starting address of a new portion of code for an updating/debugging procedure within the second memory 412. As such, a program executed by the processor 410 may branch to a particular patch address of A_{patch}_{_{—}}₁-A_{patch}_{_{—}}ₘ if a match between the first output address Sₒ_{_{—}}₁ and a particular predetermined address of Aₚᵣₑ_{_{—}}₁-Aₚᵣₑ_{_{—}}_{z} acting as the bug address occurs.

Summarily, the processor 430 generates the first output address Aₒ_{_{—}}₁ initialized to access the first memory 411 and determines whether the first output address Aₒ_{_{—}}₁ needs to be replaced with an address accessing the second memory 412 before providing the second output address Aₒ_{_{—}}₂ selected based on the determination to access the memory unit 410. As such, addresses being patched, repaired or expanded are determined and replaced before being sent to the ROM (the first memory) to prevent unnecessary access of the ROM in the invention, unlike conventional circuits 100, 200 and 300 where these addresses are still sent to the ROM. In addition, patch addresses in place of the addresses being patched, repaired or expanded are sent to the memory unit 410 in the invention rather than the processor 102, multiplexer 86 or counter 305 respectively in the conventional circuits 100, 200 and 300. Redirecting or resetting of the address selection unit 432 is thus not required and normal process generating the next address of the ROM is not interrupted.

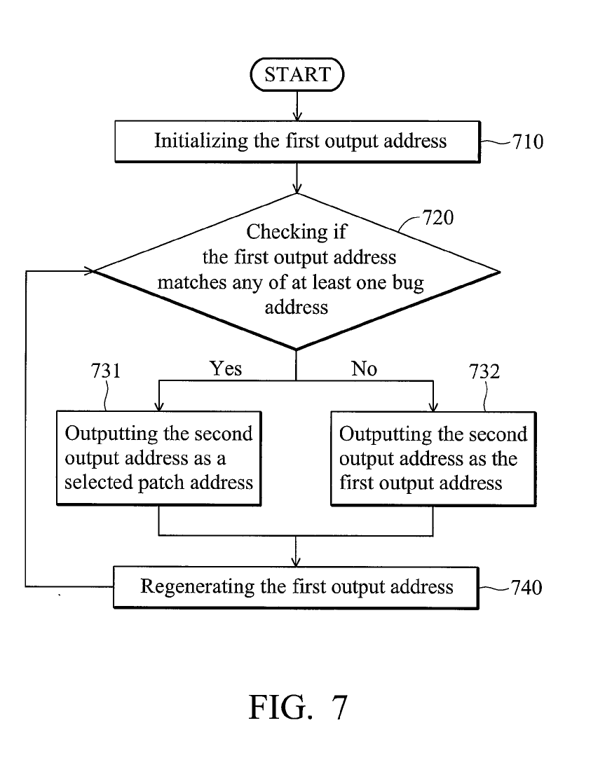

FIG. 7 is a flowchart of a microcode patching method of the invention in accordance with an embodiment of the invention, the method accessing a memory unit comprising a first memory storing at least one microcode main instruction and a second memory storing at least one microcode patch instruction.

First, in step 710, a first output address is initialized to access one address of the first memory. More specifically, the first output address in selected from at least one input address for accessing the first memory, such as a destination address produced by an instruction decoder to read a branch instruction stored in the first memory, a start address produced by an interruption control unit to access interruption processing code stored in the first memory, and etc.

Next, in step 720, whether the first output address matches any of the bug address is determined.

If so (Yes), the process enters step 731 to provide a selected patch address of the second memory as a second output memory and the second output address is used to access the memory unit. In an embodiment of the step 731, at least one patch address respectively corresponding to the bug address is provided, and one of the patch addresses corresponding to the bug address matching the first output address is selected as the selected patch address.

If not (No), the process enters step 732 to output the first output address as the second output address, and the second output address is used to access the memory unit.

Next, in step 740, the first output address is regenerated and the process returns to step 720. In an embodiment, an address next to the second output address is first generated, and then the first output address is selected from the input address described in step 710 and the address next to the second output address.

Summarily, the first output address initialized to access the first memory is determined whether to be replaced with an address accessing the second memory before the second output address selected based on the determination is provided to the memory unit. As such, addresses being patched, repaired or expanded are replaced before being sent to the ROM (the first memory) and unnecessary access of the ROM is prevented. This differs from the conventional circuits 100, 200 and 300 where addresses being patched, repaired or expanded are still sent to the ROM. In addition, patch addresses in place of the addresses being patched, repaired or expanded are sent directly to the memory unit and no redirecting or resetting is needed.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A microcode patching system, comprising:
a memory unit comprising a first memory storing at least one microcode main instruction and a second memory providing at least one microcode patch instruction, accessed according to a selected output address;
an address selecting unit providing a first output address; and
a trap and patch logic unit coupled between the address selecting unit and the memory unit, determining if the first output address matches any of at least one bug address, and selecting a selected patch address for accessing the second memory or the first output address as a second output address if the first output address matches one or none of the bug address, respectively, wherein the second output address is coupled to the memory unit.

2. The microcode patching system as claimed in claim 1, wherein the first memory is a read only memory.

3. The microcode patching system as claimed in claim 1, wherein the second memory is a random access memory.

4. The microcode patching system as claimed in claim 1, wherein the address selecting unit receives a plurality of input addresses and selects one thereof as the first output address, wherein the input addresses comprises at least one address for accessing the first memory.

5. The microcode patching system as claimed in claim 4, wherein the input addresses further comprise an address next to the second output address.

6. The microcode patching system as claimed in claim 1, further comprising:
an address register registering the second output address from the trap and patch logic unit; and
an address incrementer incrementing the second output address received from the address register to provide the address next to the second output address.

7. The microcode patching system as claimed in claim 6, wherein the address register is coupled between the trap and patch logic unit and the memory unit and provides the second output address to the memory unit.

8. The microcode patching system as claimed in claim 1, wherein the bug address respectively corresponds to at least one patch address, and the trap and patch logic unit selects a corresponding patch address as the selected patch address if the first output address matches one bug address.

9. The microcode patching system as claimed in claim 1, wherein the trap and patch logic unit comprises:
a comparison module determining if the first output address matches any of at least one bug address and outputting an address selecting signal indicating which of the bug addresses matches the first output address; and
an address selector receiving the address selecting signal and the first output address, and if the selecting signal indicates one bug address match with the first output address, selecting a corresponding patch address as the selected patch address and providing the selected patch address as the second output address, or otherwise, selecting the first output address as the second output address.

10. The microcode patching system as claimed in claim 8, wherein the trap and patch logic unit comprises:
a comparison unit determining if the first output address matches any of at least one predetermined address comprising the bug address and outputting a match signal indicating which of the predetermined addresses matches the first output address; and
an enable logic unit determining enable status of the match signal to provide the address selecting signal indicating which of the predetermined address set enabled matches the first output address.

11. A microcode patching method for accessing a memory unit comprising a first memory storing at least one microcode main instruction and a second memory storing at least one microcode patch instruction comprising:
providing a first output address;
determining if the first output address matches any of at least one bug address;
outputting a second output address as a selected patch address for accessing the second memory or as the first output address if so and if not, respectively, and accessing the memory unit according to the second output address.

12. The method as claimed in claim 11, wherein provision of the selected patch address for accessing the second memory as the second output address comprises:
providing at least one patch address respectively corresponding to the bug address; and
selecting one of the patch addresses corresponding to the bug address matching the first output address as the selected patch address.

13. The method as claimed in claim 11, wherein the first memory is a read only memory.

14. The method claimed in claim 11, wherein the second memory is a random access memory.
